(19) United States
(12) Patent Application Publication
(10) Pub. No.: US 2003/0050851 A1
(43) Pub. Date: Mar. 13, 2003

(54) Hybrid business model having infinitely variable business support services

(76) Inventor: Lee P. Vaccaro, Tampa, FL (US)

Correspondence Address: John H. Faro, Esq., Faro & Associates, P.O. Box 4904, Key Biscayne, FL, 33149-4904, US

(21) Appl. No.: 10/002,321

(22) Filed: Nov. 15, 2001

Related U.S. Application Data
(60) Provisional application No. 60/311,300, filed on Aug. 10, 2001.
(60) Provisional application No. 60/294,828, filed on May 31, 2001.

(51) Int. Cl. G06F 17/60

(52) U.S. Cl. 705/26

(57) ABSTRACT

A hybrid business model incorporating elements from both e-commerce and traditional business support services, specifically, a service center comprising an independent business support staff having expertise in the relevant e-commerce business. The individuals within the service center are linked together via a mobius loop telecommunications network; and, such network is infinitely variable to permit addition or deletion of service center personnel, based upon fluctuations in business volume. The preferred order processing protocol available for the customer of the system includes a “bank-pay” option permitting the customer to obtain a deposit slip for an e-commerce business, and thereby directly deposit his purchase payment into a designated depository account of the e-commerce business. The option affords the customer additional savings by reducing the credit card merchant fees paid by the e-commerce business and consumer interest charges paid to the credit card processor.

### CROSS-REFERENCE TO RELATED APPLICATIONS

This application is a continuation-in-part and claims priority to prior filed Provisional Application Ser. No. 60/311,300, filed Aug. 10, 2001, and Provisional Application Ser. No. 60/294,828 filed May 31, 2001.

### BACKGROUND OF INVENTION

1. Field of the Invention

This invention relates to a system and to a method. More specifically, this invention relates to a hybrid business model incorporating elements from both e-commerce and traditional business support services, specifically, a service center comprising an independent business support staff having expertise in the relevant e-commerce business. The individuals within the service center are linked together via a mobius loop telecommunications network; and, such network is infinitely variable to permit addition or deletion of service center personnel, based upon fluctuations in business volume.

In one of the alternative embodiments of this invention, the service center provides customer support services for competing e-commerce business sites engaged in the promotion of essentially the same categories of commercial goods and/or services.

In another of the alternative embodiments of this invention, the order processing protocol for the customer order includes a “bank-pay” option permitting the customer to obtain a deposit slip for an e-commerce business, and thereby directly deposit his purchase payment into a designated depository account of the e-commerce business. The option affords the customer additional savings by reducing the credit card merchant fees paid by the e-commerce business and consumer interest charges paid to the credit card processor.

2. Description of Prior Art

The e-commerce experience has and continues to be the source of many bittersweet lessons for the business enterprise engaging in this form of solicitation and distribution, namely, that (a) the electronic marketplace is not overhead insensitive; and, (b) traditional customer and business interaction is both essential to not only creating a positive, initial sale experience, but also critical for repeat business.

The reasons for the foregoing conclusions are simple: most retail and business customers that use e-commerce as a starting point (e.g. screening tool) for a prospective commercial transaction are both busy and, yet sophisticated enough to realize their knowledge base (e.g. expertise) is incomplete. More specifically, many of the e-commerce retail or business consumers, preliminary to initiation of a purchase, have become sufficiently familiar with the products and services of interest to them, or have a fairly good understanding of their own needs and requirements, to undertake a focused pursuit of the product or service which they believe will satisfy such needs and requirements. Notwithstanding, such focused consumers only have a limited amount of time and energy to devote in the search and selection of the best product and/or service at the best price. Accordingly, the selection process is still limited by the consumer's intelligence gathering, and the suitability of the ultimate selection to meet their own needs and requirements, by their knowledge at the time such purchase is made. In a number of instances the consumer makes an inappropriate selection and the product must be returned, which process is relatively cumbersome and further detracts from the e-commerce shopping experience. To date, e-commerce business enterprises have been generally non-responsive to need for the provision of personalized consumer assistance in the product selection process; and, their solution to easing the return experience has been the inclusion of the return shipping label with the shipment.

With very limited exception, where e-commerce business has attempted to supplement its electronic marketplace presentation on the Internet with customer support personnel on the phone, the additional costs for customer support personnel (salaries, benefits, office space, telephone lines, office equipment, employee training and turnover, etc.) generally increases the e-commerce overhead burden so as to reduce the margins below the level to sustain profitability. Thus, e-commerce enterprise based business, with the notable exception of on-line brokerage firms, have lost their luster, and the few that have managed to survive the exhaustion of investor capital, are marginally profitable.

The retail and business consumer is the forgotten participant in this e-commerce scenario, who, for reasons of convenience and possibly pure entertainment value, still prefers the freedom and almost limitless landscape available for browsing on the Internet. Notwithstanding, this “video game” like fascination with e-commerce browsing, the retail and business consumer is not going to continue to patronize e-commerce business, as before, without substantial improvements in customer support both in the product selection and post sale support. Up to now, the squeeze on profit margins of e-commerce business has, however, made this level of customer support impractical and uneconomic. Accordingly, for e-commerce business to thrive, there continues to exist a need to enhance e-commerce business customer support services, and yet minimize the overhead burden on such e-commerce business in the provision of such support services.

A number of suggestion for improvement in resolving customer complaints relative to e-commerce service and support have appeared in the patent literature. The following patents are representative of such efforts:

U.S. Pat. No. 6,223,165 (to Lauffer, issued on Apr. 24, 2001) discloses a method of facilitating the delivery of advice to consumers using a server unit which can store and display the names and characteristics of experts and then rapidly assist in connecting the expert and consumer for real-time communication. The server can also have the ability to receive keywords from the consumer, match those keywords to one or more experts, and tell the consumer how to contact an expert. The Lauffer method reportedly has application in providing responses to customer inquires relating to e-commerce business solicitations.

U.S. Pat. No. 6,195,651 (to Handel, et al., issued on Feb. 27, 2001) discloses a system that facilitates a web-based user interface to a particular application program that is enabled by obtaining user profile information, parsing the content of the particular application, matching the parsed content to user profile information and presenting the parsed content matches in a format based on information in the user's profile on a display. An innovative pattern matching system is integrated into the match processing to provide improved matching capability. The Handel, et al., reportedly has application in providing responses to customer inquires relating to e-commerce business solicitations.

U.S. Pat. No. 6,134,548 (to Gottsman, et al., issued on Oct. 17, 2000) discloses a system that facilitates web-based comparison shopping in conventional, physical, non-web retail environments. A wireless phone or similar hand-held wireless device with Internet Protocol capability is combined with a miniature barcode reader, (installed either inside the phone or on a short cable); and, which is utilized to obtain definitive product identification by, for example, scanning a Universal Product Code (UPC) bar code from a book or other product. The wireless device transmits the definitive product identifier to a service routine (running on a Web server), which converts it to (in the case of books) its International Standard Book Number or (in the case of other products) whatever identifier is appropriate. The service routine then queries the Web to find price, shipping and availability information on the product from various Web suppliers. This information is formatted and displayed on the hand-held device's screen. The user may then use the hand-held device to place an order interactively.

In each of the foregoing instances, the above enhancement to e-commerce business attempt to address one or more recognized shortcomings by proposing, in the case of the Lauffer, direct customer access to expert assistance, in the case of Handel, et al., the matching of a consumer created profile with a specific need or requirement of the consumer, and, in the case of Gottsman , et al., the substitution of hardcopy of an e-commerce catalog to permit direct telephonic access to price and other product specific information through a proprietary database responsive to a bar-code like data inquiry. Notwithstanding such efforts, the impersonalization of e-commerce transactions remains a considerable obstacle to growth and acceptance of this commercial engine in all but simple transactions (e.g. ordering of a book or music CD). Moreover, the availability of a manufacturer's Web pages does not remove such inadequacies nor provide the requisite assistance in an acceptable time-frame.

This institutionalized lack of a personal contact between the customer and the e-commerce business is also counter-productive because its limits sales volume to the initial product selection, and thereby an “up-sale” opportunity to sell additional products, if not lost, is postponed to a later contact or date. Accordingly, there continues to exist a need to further enhance the e-commerce business transaction by providing increased interpersonal contact between the customer and the e-commerce business representative, while at the same time minimizing the cost of such interpersonal contact to e-commerce business.

### OBJECTS OF THE INVENTION

It is the object of this invention to remedy the above, as well as related deficiencies in the prior art.

More specifically, it is the principle object of this invention to provide a hybrid business model based upon a system and method (a) for solicitation and consummation of an e-commerce business transaction and (b) provision of a high level of customer sales & technical support, without maintaining a physical location, inventory, shipping facilities, or employing either account reconciliation personnel or sales and technical support personnel.

It is another object of this invention to provide a hybrid system for solicitation and consummation of an e-commerce business transaction, wherein the consummation of the business transaction (e.g. order taking, processing of credit card payment, order confirmation, shipping, etc.) is performed without any incremental change (increase or decrease) in overhead expense to the e-commerce business.

It is yet another object of this invention to provide a hybrid system for solicitation and consummation of an e-commerce business transaction, wherein the consummation of the business transaction is performed through a support service center without any incremental change (increase or decrease) in overhead expense to the e-commerce business.

It is still yet another object of this invention to provide a hybrid system for solicitation of consumer business for the essentially the same or similar products through multiple e-commerce business sites and the consummation of such transactions through a common service center specific for providing customer support services for the products promoted on the multiple e-commerce business sites.

It a further object of this invention to provide an infinitely expandable service center based upon a telecommunication network of sales and support personnel who are linked together via a unique seamless call processing routine which utilizes a mobius loop-like array, wherein each incoming call is referred to or, alternatively, forwarded to an available sales and support personnel within the loop and, until answered.

Additional objects include a method for execution of an e-commerce consumer transaction which includes a direct funds transfer between the consumer and the e-commerce business (also hereinafter “Bank-Pay” or “EZ Bank-Pay” option).

### SUMMARY OF THE INVENTION

The above and related objects are achieved by providing a system and method for solicitation and consummation of e-commerce transactions without any incremental change in overhead expense as a consequence of changes in transaction volume. As more fully set forth herein, the system and method of this invention permit a business to solicit sales and consummate such sales without maintaining a physical location, inventory, shipping facilities, account reconciliation personnel or sales and technical support personnel.

The solicitation of a consumer transaction is accomplished in accordance with the system and method of this invention via a combination of Internet Web Page (also “e-commerce business”) promotion, in conjunction with independent sales & technical support personnel, who are compensated based upon individual sales performance. These independent sales & technical support personnel are part of an infinitely expandable (amorphous and virtual) service center, wherein each such individual is linked to one another in a mobius loop-like telecommunication network. More specifically, these personnel are linked together via an extended call forwarding routine, wherein each incoming consumer inquiry is referred to one of these personnel in accordance with his priority position within the telecommunication network, or, alternatively, forwarded to the next available sales and support personnel within the telecommunication network, until such call is answered.

In one of the preferred embodiments of this invention, incoming calls are generated by solicitation of consumers to call a telephone number (also “listed” or “business” number) within their geographically distinct locality. This listed telephone number is preferably unattended and simply provides a telecommunication portal (e.g., Extended Call Forwarding (ECF)) which distributes such incoming calls in accordance with a mobius loop-like call forwarding routine to an available sales and/or support personnel. The intelligent forwarding and roll-over features of this mobius loop-like call forwarding routine integrates the population of available sales and support personnel into a coherent (virtual) service center environment that provides essentially seamless response to such customer calls. Where call volume is anticipated to increase because of seasonal or holiday shopping, additional independent sales & technical support personnel are added to the telecommunication network, by simply inclusion of their phone numbers (e.g. home or cell phones) within the mobius loop array of personnel within the telecommunication network. Because of the unique roll over and forwarding capability of the telecommunications network, the personnel within the telecommunication network need not be located at a centralized location, or for that matter, within the same geographic locality. In the preferred embodiments of this invention, each incoming call would be forwarded to a telecommunications network within the same area code, or to personnel within a call area that would not incur any toll charges for either the customer or the e-commerce business (e.g. NEXTEL providing toll free calling within all area codes throughout the State of Florida).

As noted above, because each telephone number within a given telecommunications network has an assigned priority relative to one another, an incoming call is routed to each such telephone numbers in order of its assigned priority within the array. Where, for example, a priority number in the network is busy or otherwise unavailable (e.g., unattended), the incoming call is rolled over, or forwarded, to the next priority number within the network, and so forth and so on, until the call is answered. The network provides for essentially continuous roll over and forwarding of an incoming call until it is answered. In the preferred embodiments of this invention, a customer would be able to contact the same sales and support personnel by queuing in an identification code which is provided to him by such personnel, or which accompanies his order confirmation.

In the preferred embodiments of this invention, the sales & support personnel have access/links to an order processing protocol that is integrated within the e-commerce business Web Site, specifically, (a) the various products offered on the e-commerce business Web Site, (b) an order payment function, (c) a supplier/fulfillment house that maintains a stock of products offered by the e-commerce business, (d) a courier/shipper responsible for deliver of the order merchandise and (e) an accounting function which pays the vendor and shipper, the web hosting service, the telecommunication network.

The system and method of this invention also incorporate into this order processing protocol a unique order payment function wherein order processing is expedited by providing, or, alternatively, requiring the customer to electronically pay for his merchandise purchase via a direct electronic transfer of funds from the customer into a receivables account of the e-commerce business. This is accomplished simply by providing, incident to the processing of the customer's order, an electronic or physical deposit slip for the e-commerce business receivables account. The consumer would use this deposit slip to effect a deposit (funds transfer) into the e-commerce business receivables account. Thus, the merchant discount charges by the credit card companies would be eliminated; and, the e-commerce business would receive payment almost immediately, instead of the 30 to 60 day delay attendant to the credit card company's processing of credit card and debit card charges.

Accordingly, the processing of the customer order is held in queue, pending confirmation of a funds transfer by the customer to the e-commerce business sufficient to pay for purchase price, and the costs associated with packing and shipping. This direct electronic transfer of finds between customer and the e-commerce business, hereinafter also “Bank Pay” option, not only eliminates the merchant discount that the e-commerce business is required to pay to the credit/charge card companies; but also the return penalties incurred by such e-commerce businesses in the event the purchase is subsequently voided by the consumer and a credit issued by the e-commerce business, through the credit/charge card company, to the consumer.

### BRIEF DESCRIPTION OF THE DRAWINGS

FIG. 1 is a flowchart providing an overview of a hybrid business model of the system of this invention.

FIG. 2 is a flowchart providing an expanded view of the mobius loop telecommunications network module of the system of this invention.

FIG. 3 is a further illustration of a representative embodiment of the mobius loop telecommunication network module of FIG. 2.

FIG. 4 is a flowchart providing an expanded view of the bank-pay module of the system of this invention.

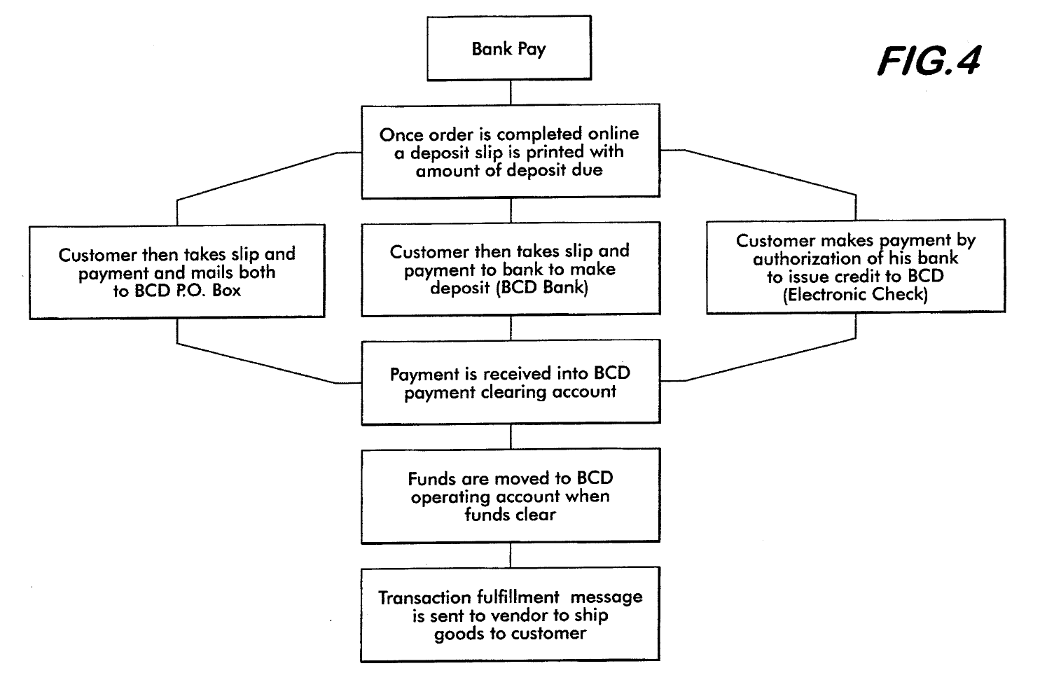

### DESCRIPTION OF THE INVENTION INCLUDING PREFERRED EMBODIMENTS

The hybrid business model of this invention is described in reference to the accompanying Figures. It is understood that the elements of this model include both e-commerce and traditional business support services.

System Overview

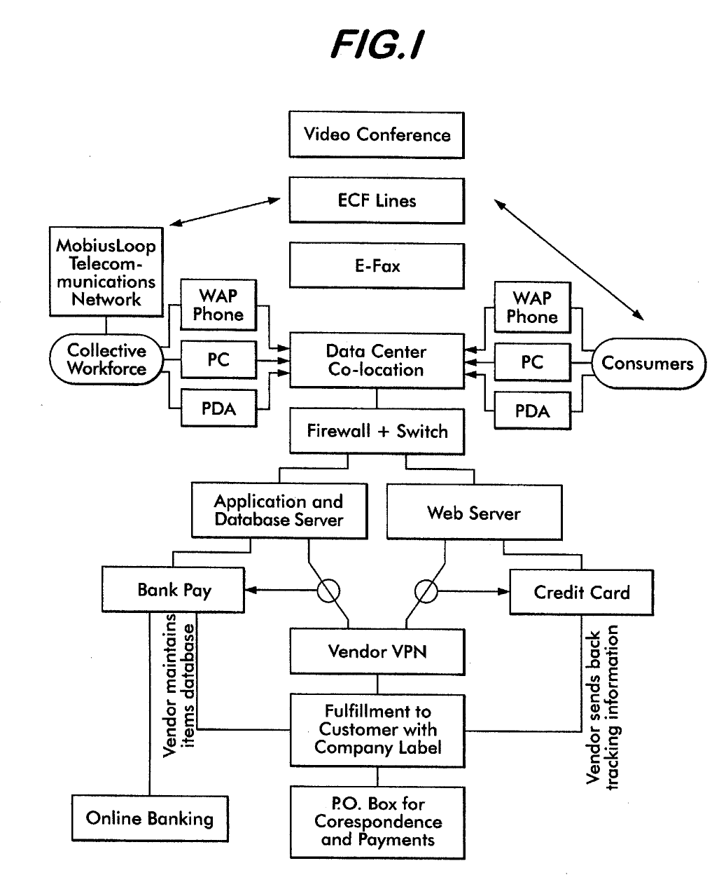

By way of summary and illustration, FIG. 1 provides a flowchart showing the features and modules of the system of this invention as they interact with one another to provide an integral hybrid business model. In FIG. 1, a representative e-commerce business system can include an established Web Site that can be accessed by the consumer through his personal computer (PC). Alternatively, the Web Site is also accessible by means of a Wireless Application Protocol based telephone (WAP) or a Personal Digital Assistant (PDA), such as a Palm Pilot or comparable device. The consumer thereby gains access to the e-commerce business Web Site, and proceeds to browse and make tentative selections, or eliminate those products which are unacceptable, or which he believes may be unacceptable. Notwithstanding, customer browsing is both finite limited, and consumer knowledge assumed to be imperfect, thus, requiring live/interactive, real-time customer or technical support to assist the customer to complete his education and assist in the selection of his purchase.

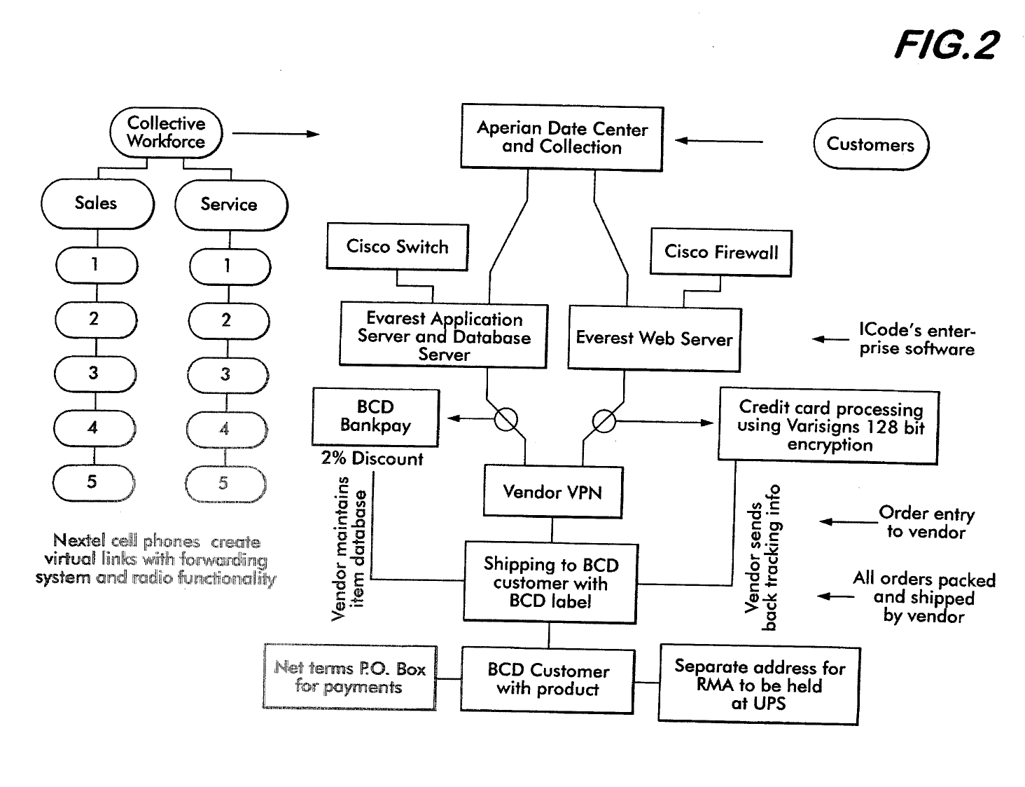

At this juncture, the consumer is prompted to contact a service center to assist him in his purchasing decision and, thereafter, in the implementation of such decision. Access to the service center can be channeled through the Web Site, or alternatively, the customer directed to a toll free number, preferably while maintain on-line access to the Web Site. The toll free number accessible to the customer is based upon his location and the calling area serviced by such number. These numbers preferably include a listed or business number that is geographically distinct, or area code defined, so as to provide toll free access to the service center. The service center is represented and defined in terms of a Telecommunications Network, having a mobius loop architecture, as illustrated in FIGS. 2 & 3. In order to more readily comprehend the operation of the mobius loop architecture of the Telecommunication Network Module (TNM), it is appropriate to initially review the call handling capabilities thereof. The TNM operates upon the assumption that there are more than sufficient personnel available to provide for realtime/live support and service; and, that each of the personnel associated with a given TNM has the requisite sophistication to assist any customer as to products and services offered by the e-commerce business. In one of the preferred embodiments of this invention, each of the personnel within the TNM are also seamlessly linked to one another to assist each other in responding to a customer inquiry. Telecommunications equipment suitable for use in the TNM includes the Nextel cellular phones having both cellular and radio frequency functionality. The Nextel based TNM creates a “hive-like” environment wherein each of the hive members are and remain accessible to one another to both support and compliment one another's activities within the hive.

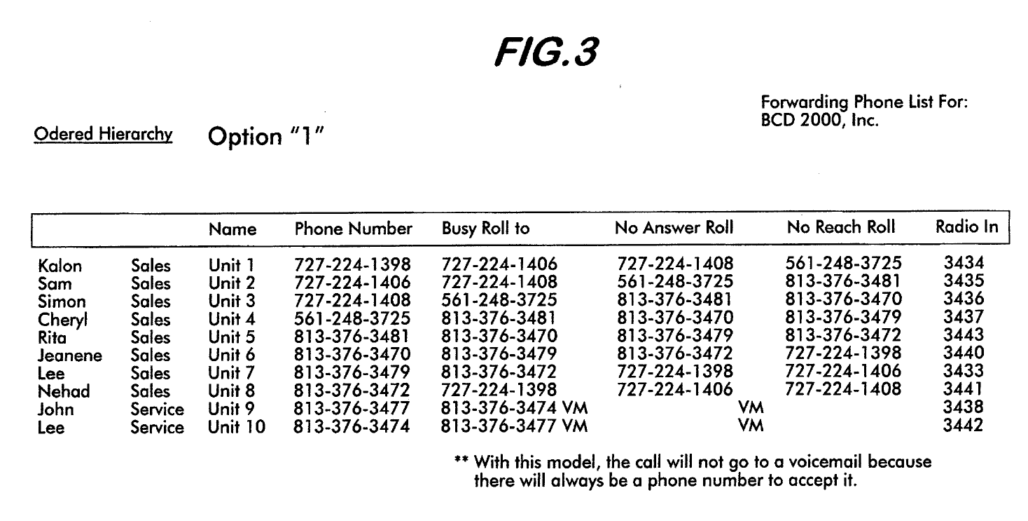

In a typical TNM, the mobius loop protocol operates either automatically, based upon a pre-set call-forwarding/roll-over routine, or in accordance with a flexible protocol that is infinitely variable, based upon the call handling selections made by each member of the hive. More specifically, as illustrated in FIG. 2, an incoming call is routed to a given hive with a defined geographically or area code from a local, listed business number within the customer's calling area. It is emphasized, the this local, listed business number is not a “toll-free” number in the traditional use of such phrase, because the customer call does not cost either the customer or the e-commerce business any access charges, other than a fixed, basic monthly fee for an Extended Call Forwarding (ECF) service. Based upon call handling selections made by the hive member, the call can be answered by the hive member having the premier position (numerically determined) within the hive hierarchy (Option No. 1 of FIG. 2), or the call rolled to a hive member at a different position within the hierarchy (Options No. 2, or 3 of FIG. 2). The term “hierarchy” is used herein to denote an order of call handing, and not intended to indicate a different level of service of experience among the hive members. Where a hive member is not participating in the hive activity on a given shift or date ((Option No. 4 of FIG. 2), his phone is simple turned off, and the customer call rolled over to another hive member whose phone is active. FIG. 3 is an Excel spreadsheet illustrating a hierarchy of hive members, based upon numerical ordering of telephone numbers.

In one of the preferred embodiments of this invention, the hierarchy of hive members responding to a given customer inquiry can be customer directed, based upon voice prompts to a customer, or upon his special needs, (e.g., Customer inquiry specific as to compatibility of certain hardware or driver requirements and a new operating system, such as Windows 2000, Professional Edition).

Once the customer has contacted the service center, and made his purchasing decision, the order processing protocol of the system can then be implemented. In the system of this invention, the customer has the option of selection from among at least three (3) payment options: traditional credit card charging of his purchase; traditional debit card charging of his purchase; and, a unique, direct deposit of his payment in an e-commerce business account (also herein “Bank-Pay” option). This Bank-Pay option can be selected, wherever available, by causing the system to issue a deposit slip in the amount of the customer purchase. The customer then takes the deposit slip to an e-commerce designated depository bank, and deposits the amount of the purchase into the e-commerce business account. The deposit results in the generation of receipt which preferably includes a transaction number that corresponds to the customer's purchase order on the system. At the close of the banking day, or throughout the banking day, the e-commerce business account can be interrogated, or automatically issues a report, confirming a Bank-Pay transaction along with the purchase order number corresponding to such Bank-Pay transaction. This confirmation causes the customer order to be released and forwarded for further processing. The transaction processing savings (e.g. merchant discount traditional paid by the e-commerce for a comparable credit card transaction) is shared with the customer, and preferably the amount of such savings realized by the customer, reflected upon his invoice at the time of selection of the Bank-Pay option. The e-commerce business realizes immediate improvement in cash flow, as do the suppliers to the e-commerce business.

System Detail

Order Solicitation—The solicitation process can differ depending upon the nature of the business enterprise, the existence of a traditional outlet for the goods of the business enterprise and the existence of a customer base from whom to solicit additional business. For example, where the business enterprise has an existing and established outlet, the business enterprise solicitation can present its customers with a choice, either frequent the physical location of the business enterprise, or use the corresponding Web Site to browse for items of interest, and thereafter either purchase their selection from the establish business enterprise outlet or utilize the on-line referral to a service center for assistance in the completion of the purchase transaction.

Where the business enterprise does not have an existing outlet and/or an established customer base, it can either promote its Web Site by advertising (hot links) at other more established sites, or simply engage in direct email or snail mail solicitation. In each instance, the customer prospect is directed, as above, to an experienced sales personnel assist the customer in ordering of his needs or requirements.

The customer contact can be channeled through a voice link on the business enterprise Web Page, or a conventional telephone line, to a business enterprise representative. In each instance, experienced sales personnel assist the customer in ordering of his needs or requirements, and, where possible, advise the customer of additional items (up-sale) that may be of interest or complimentary to the primary purchase. The personal contact between the customer and the business enterprise sales representative assures the customer of personal service and creates the opportunity for additional business.

Telecommunications Network—In the preferred embodiments of this invention, incoming calls are generated by solicitation of consumers to call a telephone number (also “listed” or “business” number) within their geographically distinct locality. As illustrated in FIG. 1, this listed telephone number is preferably unattended and simply provides a telecommunication portal (e.g., Extended Call Forwarding (ECF)) which distributes such incoming calls in accordance with a mobius loop-like call forwarding routine to an available sales and/or support personnel. The intelligent call forwarding and roll-over features of this mobius loop-like call the system's answering protocol integrates the population of available sales and support personnel into a coherent (virtual) service center environment that provides essentially seamless response to such customer calls. Where call volume is anticipated to increase because of seasonal or holiday shopping, additional independent sales & technical support personnel are added to the telecommunication network, by simply inclusion of their phone numbers (e.g. home or cell phones) in the mobius loop array of personnel within the telecommunication network. In practice, as an incoming call is received, it is forwarded via an ECF line within a given locality to a telecommunication network having a population of telephone numbers arranged within a pre-defined array. Because of the unique roll over and forwarding capability of the telecommunications network, the personnel within the telecommunication network need not be located at a centralized location, or for that matter, within the same geographic locality. In the preferred embodiments of this invention, each incoming call would be forwarded to a telecommunications network within the same area code, or to personnel within a call area so as to not incur any toll charges for either the customer or the e-commerce business (e.g. NEXTEL providing toll free calling within all area codes throughout the State of Florida).

As is also evident from FIGS. 2 & 3, each telephone number within a given telecommunications network has an assigned priority relative to one another, and an incoming call is routed to each such telephone number in order of its assigned priority or hierarchy within the array. Where, for example, a priority number in the network is busy or otherwise unavailable (e.g., unattended), the incoming call is rolled over, or forwarded, to the next priority number within the network, and so forth and so on, until the call is answered. The network provides for essentially continuous roll over and forwarding of an incoming call until it is answered. The architecture of the network contemplates that a population of 25 independent sales and support personnel are capable of answering anywhere from about 650 to 750 calls per hour, thus, providing both manageable response time and adequate attention to a customer's needs. In the preferred embodiments of this invention, a customer would be able to contact the same sales and support personnel by queuing in an identification code which is provided to him by such personnel, or which accompanies his order confirmation.

Customer Support—Each sales representative of the business enterprise also has at his disposal, while the customer is in communication with him, the ability to confirm the availability of the item of interest to the customer, the shipping costs and the approximate date of delivery. Once a purchasing decision is made, the transaction is consummated in essentially the same manner as a conventional retail establishment, with one significant difference—the customer name and address (email) is now added to the business enterprise database for future direct solicitation. Moreover, the customer has the means at his disposal to readily follow-up on his initial purchase with repeat purchases without repeating the same information (e.g. name, credit card number, shipping address, etc.) by simply contacting the business enterprise Web Site, and preferably the same business enterprise representative that assisting him in his initial purchase. This ability to identify and have repeat contact with a familiar voice not only humanizes what has become an increasingly impersonal experience, but also creates a customer following that encourages repeat business.

Selection & Ordering—It is assumed for the purposes of this hybrid business model that the business enterprise has established a qualified sales and technical staff to whom the customer solicitation is referred. This is accomplished in a number and combination of ways. Obviously, the simplest means of staffing this function is to use experienced personnel that have had (and preferably continue to have) sales experience in the products of the business enterprise. Because of the versatility of the means used to access such individuals (discussed hereinafter in detail), the ability to perform this function at a multiple decentralized locations (e.g. home office), and the flexibility in the hours required to staff such positions, the number of qualified individuals will generally exceed the anticipated, normal trade volume. Having said that, the versatility of this business model permits expansion of the available sales and support personnel by simply adding additional telephone numbers to the network to accommodate such anticipated increase in call volume.

Order Entry & Fulfillment—In the preferred embodiments of this invention illustrated in FIG. 1, the system and method incorporate into this order processing protocol a unique payment processing function wherein order processing is expedited by providing, or, alternatively, requiring the customer with the option to electronically or to manually pay for his merchandise purchase. In one option, the customer transaction is processed using a credit or debit card charge on a secured network. Alternatively, the customer selects a manual payment option via a direct deposit of funds from the customer into an account of a designated depository bank in which the e-commerce business has established an account This is accomplished simply by providing, incident to the processing of the customer's order, an electronically generated physical deposit slip in the amount of the e-commerce business transaction. More specifically, as part of the ordering process, the customer selects from among a number of payment options. Where the direct or manual Bank-Pay option is selected, or alternatively, incidental to the generation and printing of an invoice for the customer purchase, the customer is presented with a combined invoice/deposit slip, reflecting a discount associated such manual/direct Bank-Pay option (typically 2-3%). By electing the manual/direct Bank-Pay option, the merchant discount charged to the e-commerce business by the credit card companies would be eliminated; and, the e-commerce business would receive payment almost immediately, instead of the 30 to 60 day delay (float) attendant to the credit card company's processing of credit card and debit card charges.

Upsale & Re-orders—The service center environment afforded by the telecommunications network module of the system of this invention provides opportunities that are unique to live personal contact, and interaction, between a customer and customer service/support personnel. The opportunities presented include the up-sale of a featured or promoted item; or, where there have been a prior favorable sales experience, the renewal of the customer service/support personnel contact at a later date when the customer desires to place another order. More specifically, in each instance the customer service/support personnel (who are generally compensated entirely from earned sales commissions) have an incentive to make the customer happy—generate “good will” on behalf of the business, and a customer following within the e-commerce business environment This good will accrues directly to the e-commerce business and remains with the business—a very significant advantage during the age of the peripatetic employee. More specifically, the unique configuration of the system precludes employee diversion of customer and business, resulting from employee turnover since the customer service personnel do not have access to the order processing information. Accordingly, the customers of the e-commerce business remain the customers of the e-commerce business so long as the system favorably provides for their needs. Moreover, competent customer service personnel remain loyal to the e-commerce business either because of the compensation or because there is no incentive to leave. Accordingly, the competent personnel are retained and, and the marginal performers are simply weeded out.

This hybrid business model has application to competitive marketing of computer related and electronic products, health care products and prescription drugs.

What is claimed is:

1. In a system for on-line processing of an e-commerce business transaction involving customer supported selection, ordering and payment for a purchase, the improvement comprises:
A. A telecommunication network having a mobius loop call answering protocol for directing incoming telephone calls from potential customers to phone answering stations within said network in accordance with a hierarchy established for said network for handling said incoming phone calls,
whereby each incoming call is answered in an order defined by said hierarchy, or in accordance with a prompt to said network from a caller, or in accordance with an order defined by personnel at each of said phone answering stations, so as to provide live, realtime customer service and support to said customers of said e-commerce business; and
B. Means for effecting a sales transaction which includes an order processing protocol wherein customer payment for an order can be effected either electronically or manually, based upon customer selection and preference, by traditional credit, debit or charge card payment for said purchase at the time said order is placed, or alternatively, by generation and printing of a deposit slip, in the amount of said customer purchase, along with instructions for manually depositing said purchase amount in a depository bank designated on said deposit slip.

2. The improved system of claim 1, wherein said telecommunications network includes both a communication link to a potential customer and a communication link among said phone answering stations of said telecommunications network.

3. The improved system of claim 1, wherein said telecommunications network includes telecommunications portal providing extended call forwarding for funneling prospective customer calls into said telecommunication network, said telecommunications portal including a local number so as to provide both a prospective customer toll free access to said e-commerce business and said e-commerce business with a local identity vis-à-vis said prospective customer.

5. A method for operation of a hybrid business having infinitely variable customer service capability, said method comprising:
A. Providing a hybrid business system which includes
(1) an e-commerce business web site, said web site having a catalog of goods and/or services offered by said e-commerce business and telecommunication referral directions for enablement of a customer to contact a live-customer service and support center for said e-commerce business;
(2) a customer service and support center comprising a telecommunications module wherein said module comprises a mobius loop telephone call answering protocol for directing incoming telephone calls from potential customers to phone answering stations within said network in accordance with a hierarchy established for said network for handling said incoming phone calls,
whereby each incoming call is answered in an order defined by said hierarchy, or in accordance with a prompt to said network from a caller, or in accordance with an order defined by personnel at each of said phone answering stations, so as to provide live, real-time customer service and support to said customers of said e-commerce business; and
C. Assisting said customer with live customer service and support in his selection of purchase of a product and/or service from among products and/or services of said e-commerce business; and
D. Effecting a sales transaction for said product and/or service by customer payment for said product and/or service by election of either an electronic or manual payment option, based upon customer preference.

6. The method of claim 5, wherein said payment option is selected from the group consisting of a credit card, a debit card, a charge card, or by generation and printing of a deposit slip, in the amount of said customer purchase,
said deposit slip including direction for manually depositing said purchase amount in a depository bank designated on said deposit slip.
